(19) United States
(12) Patent Application Publication
(10) Pub. No.: US 2002/0172000 A1
(43) Pub. Date: Nov. 21, 2002

(54) Sensor and method for the manufacture thereof

(76) Inventors: Klaus Walter, Bietigheim-Bissingen (DE); Guenter Escher, Oberstdorf (DE); Juergen Toepfer, Ingelheim (DE)

Correspondence Address: KENYON & KENYON, ONE BROADWAY, NEW YORK, NY, 10004, US

(21) Appl. No.: 10/107,672

(22) Filed: Mar. 27, 2002

(30) Foreign Application Priority Data
Mar. 30, 2001 (DE) 101 16 019.4-52

(51) Int. Cl. H02B 1/00

(52) U.S. Cl. 361/600

(57) ABSTRACT

A sensor includes a retaining part, an electronic system, and a cup-shaped element The electronic system of the sensor is received in the cup-shaped element, the electronic system being sealed in the cup-shaped element by way of a sealant. The cup-shaped element is secured to the retaining part. A method for manufacturing a sensor is also made available.

### FIELD OF THE INVENTION

The present invention relates to a sensor or a measurement apparatus, in particular for non-contact sensing of a rotation speed or rotation angle, as well as a method for manufacturing such a sensor.

### BACKGROUND INFORMATION

Sensors are known in a wide variety of embodiments. Sensors usually are constructed in such a way that the sensor electronic system is encased in an injection-molding compound made of plastic. Such sensors are of simple construction and can be manufactured economically. In particular when such sensors are used in motor vehicles, however, it is disadvantageous that each motor vehicle manufacturer stipulates, in particular, specific plug connectors or installation geometries, so that for each motor vehicle manufacturer, a separate injection mold is necessary for the sensor. This makes manufacture of the particular sensors more expensive, since a differently configured sensor is required for each customer.

In addition, sensors of this kind are in some cases used in motor vehicles in extreme environmental conditions, e.g. at high temperatures or in contact with external media (e.g. oil. fuel). In particular, a transmission sensor, for example, is continuously surrounded by transmission oil. Injection-molded casings of this kind must therefore be produced from a media-resistant material; this increases manufacturing costs, since the use of an economical plastic might not prevent diffusion of the medium through the casing to the electronic system, and the sensor would thus be destroyed.

In order to minimize temperature influences, European Patent No. 0 632 897, for example, proposes a sensor in which portions of the electronic system are surrounded by a body made of temperature-resistant material. A sensor of this kind is, however, very expensive to manufacture.

### SUMMARY OF THE INVENTION

The sensor according to the present invention has the advantage that it can be used even under extreme conditions, e.g. in the transmission, but nevertheless can be manufactured economically. This is achieved in particular by way of a modular configuration of the sensor, which is made up of a retaining part, a cup-shaped element, the sensor electronic system, and a separate sealant. As a result of the modular configuration, the cup-shaped element and the sensor electronic system can always be configured identically, and the retaining part can be configured in each case for the customer's specific requirements, e.g. for a plug connector or the like. The electronic system of the sensor is received in the cup-shaped element, and then securely embedded in the cup-shaped element by being sealed with a cast resin. It is noted that according to the present invention, a “cup-shaped element” is understood to be an element having a base and wall parts arranged substantially perpendicularly thereto. The electronic system of the sensor can be received completely or only partially in the cup-shaped element.

In order to allow utilization of the sensor especially in extreme environmental conditions, e.g. in a transmission, the cup-shaped element is preferably made of a media-resistant plastic and in particular of an oil-resistant plastic, which prevents diffusion of the medium through the plastic to the electronic component.

The electronic system of the sensor preferably comprises a Hall element.

In particularly preferred fashion, the Hall element is arranged directly at the base of the cup-shaped element. As a result, the distance between the Hall element and, for example, a transmission gear is relatively short, since only the base of the cup and the distance from the base of the cup to the gear lie between them. Very accurate signals can thereby be received.

According to a preferred embodiment of the present invention, an introduction opening, for introducing the sealing material for the sealant, is arranged laterally on the retaining part or at the upper rim of the cup-shaped element. This allows the sealant to reach a great height in the cup-shaped element, so that the electronic system of the sensor is securely embedded in the sealant. Since the present invention provides that the same cup-shaped element and the same electronic system can always be used, within sensor families, even for sensors of different customers, the quantity of sealant is always the same for all sensors manufactured in customer-specific fashion. This yields considerable advantages in terms of manufacture.

Preferably the retaining part and the cup-shaped element are secured to one another by the cured sealant. It is noted that the retaining part and the cup-shaped element can also be secured, for example, mechanically by snap lugs or by placement of a sealing ring and subsequent press-fitting of the retaining part and cup-shaped element. In addition to the mechanical ways of joining the retaining part and the cup-shaped element, the cured sealant can then ultimately further consolidate the join.

It is particularly preferred if the sensor according to the present invention has a length greater than or equal to 30 mm. It is thereby possible to ensure that the entire electronic system is received in the cup-shaped element, and only connecting lines to the plug connector then need to be provided in the retaining part.

It is particularly preferred if the retaining part is manufactured by injection molding. As a result, it can be manufactured very economically. In particularly preferred fashion, polyamide-66 is used in this context as the plastic.

It is particularly preferred if the sensor according to the present invention is embodied as a transmission sensor that is continuously in contact with the transmission oil. In the context of use as a transmission sensor, very considerable cost savings can be achieved as compared to the existing art.

In accordance with the method according to the present invention for manufacturing a sensor or a measurement apparatus, first the retaining part is manufactured, for example by plastic injection molding. It is particularly preferred if the connecting lines to the electronic system and the plug contacts are concurrently also injection-embedded. Then the electronic system is secured to the retaining part, and the separately manufactured cup-shaped element is slid over the electronic system; the cup-shaped element is secured to the retaining part, for example, by press-fitting or by snap lugs. The method according to the present invention thus yields a preassembled component made up of the retaining part, the electronic system, and the cup-shaped element. In a subsequent method step, the component that has been preassembled in this fashion is placed obliquely and then the electronic system in the cup-shaped element is sealed in by a sealing material, e.g. plastic or resin. As a result, the electronic system is securely embedded in the cup-shaped element and surrounded by the sealing compound. Placing the preassembled component obliquely ensures that the sealing compound can flow continuously along the rim of the cup-shaped element and the electronic system. According to the present invention, sealing is thus performed with the cup-shaped element installed on the retaining part. An additional external immobilization of the cup-shaped element and the retaining part with respect to one another can also be provided between the two parts.

In particularly preferred fashion, an introduction opening for introducing the sealing compound is provided on a lateral central region of the preassembled component. A particularly short sealing compound filling time can thereby be achieved. In addition, because of the combination of oblique placement of the preassembled component and the introduction opening arranged on a lateral central region, the electronic system is securely embedded in the cup-shaped element. This also ensures that only a relatively small amount of sealing material needs to be used, so that the curing time for the sealing material is also very short.

It is particularly preferred if the introduction opening is configured between the cup-shaped element and the retaining part. Preferably a cutout or the like can be provided on the retaining part, and then serves as the introduction opening when the cup-shaped element has been mounted on the retaining part.

Preferably the preassembled component is placed obliquely at an angle of approximately 15° for introduction of the sealing material. Particularly good flow properties for the sealing material can thereby be achieved.

According to a further embodiment of the present invention, sealing of the electronic system in the cup-shaped element is accomplished under vacuum.

It is particularly preferred if during sealing, an internal region of the retaining part is also filled up with the sealing compound. It is thereby possible, in particular, to achieve an additional join between the retaining part and the cup-shaped element.

The present invention thus makes available a sensor of modular configuration which, in particular, is suitable for use even in aggressive environmental conditions. The sensor is of relatively simple configuration and can be manufactured economically. In addition, customer-specific connection geometries for the sensor can easily be implemented. The cup-shaped element moreover makes possible a high level of mechanical stability for the sensor, since the sensor electronic system can be completely received in the cup-shaped element and is protected by it. Furthermore, the method according to the present invention allows the sensor to be manufactured particularly economically.

It is particularly preferred if the cup-shaped element is configured as a rotationally symmetrical cup, i.e. with a cylindrical enveloping shape and a base.

### BRIEF DESCRIPTION OF THE DRAWINGS

FIG. 1 is a perspective view, partially in section, of a sensor according to a first exemplary embodiment of the present invention.

FIG. 2 is a perspective view, rotated as compared to FIG. 1, of the sensor according to the present invention.

FIG. 3 is a perspective view of an electronic system of the sensor according to the present invention.

### DETAILED DESCRIPTION

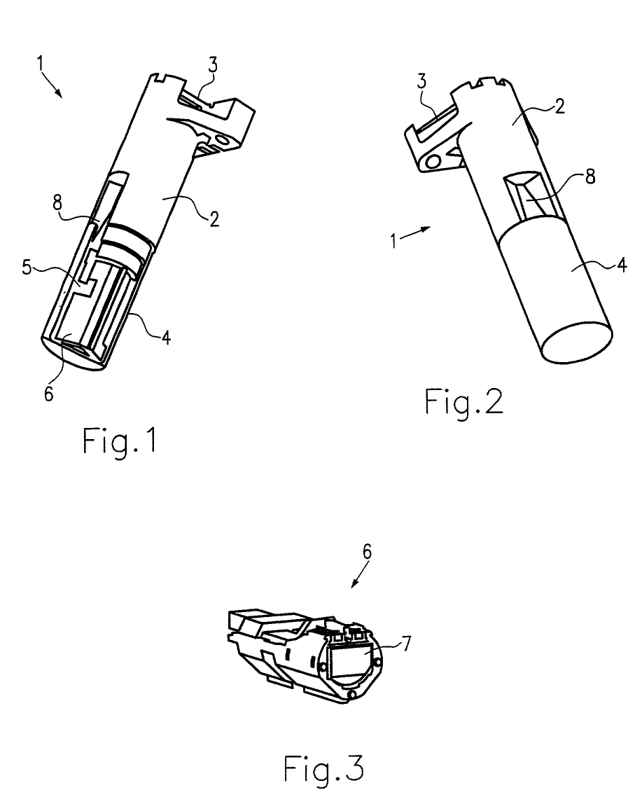

FIGS. 1 through 3 depict a sensor according to a first exemplary embodiment of the present invention.

As shown in FIG. 1, sensor 1 encompasses a retaining part 2 as well as a cylindrical cup 4. A plug connector 3 having contacts is provided at one end of retaining part 2. Also provided on retaining part 2 is an introduction opening 8 through which a plastic can be introduced in order to create a seal, as will be described later.

FIG. 3 depicts electronic system 6 of sensor 1 in more detail. Electronic system 6 includes a Hall element 7 which is located at one end of the electronic system. Electronic system 6 is inserted into cup 4 in such a way that Hall element 7 is located at the base of the cup. As a result, the distance between, for example, a gear and Hall element 7 is very short, since only the base of the cup and the distance between the base of the cup and the gear lie between them. Very accurate signals can thereby be received. Electronic system 6 can be connected, for example by soldering or laser welding, to contacts arranged on retaining part 2.

In the present exemplary embodiment, cup 4 is configured in such a way that electronic system 6 can be completely received in cup 4. Thus only connecting lines to plug connector 3 are injection-embedded in retaining part 2. It is noted that it is particularly preferred if the electronic system is manufactured together with plug connector 3, and if retaining part 2 is then insert-molded in such a way that the front region of electronic system 6 is exposed. Cup 4 can then easily be slid over electronic system 6 and secured to the retaining part, for example, on snap lugs that are provided or by press-fitting.

Sealing of electronic system 6 in cup 4 is then performed by introducing a sealing compound through introduction opening 8. For this purpose, the preassembled component made up of cup 4, electronic system 6, and retaining part 2 is placed obliquely at an angle of approximately 150, so that introduction opening 8 faces upward. The sealing compound is then poured through introduction opening 8 into cup 4, so that electronic system 6 is completely surrounded by the sealing compound. In this context, the sealing compound flows downward by gravity into the cup. Once the sealing compound has cured, electronic system 6 is securely embedded. Cup 4 offers a high level of mechanical stability.

As a result of the combination of the oblique placement of the preassembled component and the provision of introduction opening 8 in a central region of the sensor between retaining part 2 and cup 4, long sensors (having a length greater than or equal to 30 mm) in particular can be very effectively sealed. The oblique placement of the preassembled component facilitates distribution of the sealing compound in the cup-shaped element, so that the electronic system is completely and securely embedded in the sealing compound.

In FIG. 1, the partially sectioned view depicts the cured sealant 5 that surrounds electronic system 6.

According to the present invention, retaining part 2 can be manufactured economically using plastic injection molding. It is also possible in this context to adapt the plug connector and retaining part 2 to customer-specific requirements and to injection-mold a different retaining part 2 for each customer. The remaining components of the sensor according to the present invention are then customer-independent.

In order to make possible utilization, for example, as a transmission sensor, cup 4 is manufactured from a media-resistant material. It is thereby possible to prevent transmission oil from diffusing through cup 4 and damaging the electronic system of sensor 1.

The present invention thus makes available an economical sensor for non-contact reception of signals which can be used, in particular, even for sensors having a relative large overall length greater than approximately 30 mm. A further advantage of the sensor according to the present invention at such overall lengths is that temperature shock trials on the sensor can be performed even in the context of differing overall lengths and sensors for different customers, since the lower part of the sensor having cup 4 is always embodied identically for different sensors, and retaining part 2 is configured variably. This makes possible a standardized testing sequence with one standard apparatus for all sensors.

In addition, in the context of use in extreme environmental conditions, only cup 4 must be manufactured from a (costly) material which resists the prevailing environmental conditions while preventing damage to the electronic system of the sensor.

What is made available according to the present invention is thus a sensor 1 that includes a retaining part 2, an electronic system 6, and a cup-shaped element 4. Electronic system 6 of the sensor is received in cup-shaped element 4, electronic system 6 being embedded and sealed in a sealant 5 in cup-shaped element 4. Cup-shaped element 4 is secured to retaining part 2. A method for manufacturing a sensor according to the present invention is also made available.

The description above of the exemplary embodiment according to the present invention serves illustrative purposes only, and does not serve to limit the invention. Numerous changes and modifications are possible within the context of the invention without departing from the scope of the invention and its equivalents.

What is claimed is:

1. A sensor comprising:
a retaining part;
a cup-shaped element secured to the retaining part; and
an electronic system embedded in the cup-shaped element by way of a sealant.

2. The sensor according to claim 1, wherein the sensor is for a non-contact sensing of measured variables.

3. The sensor according to claim 1, wherein the cup-shaped element is composed of a media-resistant plastic.

4. The sensor according to claim 1, wherein the cup-shaped element is composed of an oil-resistant plastic.

5. The sensor according to claim 1, wherein the electronic system includes a Hall element.

6. The sensor according to claim 5, wherein the Hall element is situated directly at a base of the cup-shaped element.

7. The sensor according to claim 1, further comprising an introduction opening, for introducing a material for the sealant, situated laterally on one of the retaining part and an upper region of the cup-shaped element.

8. The sensor according to claim 1, wherein the sealant secures the retaining part and the cup-shaped element to one another.

9. The sensor according to claim 1, wherein the sensor has a length of at least 30 mm.

10. The sensor according to claim 1, wherein the retaining part is made by an injection molding.

11. The sensor according to claim 1, wherein the sensor is a transmission sensor.

12. A method for manufacturing a sensor, comprising:
providing a retaining part;
providing a cup-shaped element;
arranging an electronic system on the retaining part;
inserting the electronic system into the cup-shaped element to obtain a preassembled component;
placing the preassembled component obliquely; and
sealing the electronic system in the cup-shaped element in an obliquely placed state using a sealing material, so that the electronic system is embedded in the cup-shaped element.

13. The method according to claim 12, wherein the retaining part is provided by manufacturing the retaining part using plastic injection molding.

14. The method according to claim 12, further comprising configuring an introduction opening for introducing the sealing material into the cup-shaped element on a lateral central region of the preassembled component.

15. The method according to claim 14, wherein the introduction opening is configured between the cup-shaped element and the retaining part.

16. The method according to claim 12, wherein the preassembled component is placed obliquely at an angle of about 15°.

17. The method according to claim 12, wherein the sealing of the sealing material is performed under vacuum.
